(19) United States
(12) Patent Application Publication
(10) Pub. No.: US 2013/0124546 A1
(43) Pub. Date: May 16, 2013

(54) GROUP ACCESS CONTROL FOR A DISTRIBUTED SYSTEM

(71) Applicants: Matt A. Wormley, San Luis Obispo, CA (US); Gary B. Cohen, San Diego, CA (US); Sergiu - Andrei Dragomir, Bucharest (RO)

(72) Inventors: Matt A. Wormley, San Luis Obispo, CA (US); Gary B. Cohen, San Diego, CA (US); Sergiu - Andrei Dragomir, Bucharest (RO)

(73) Assignee: Adobe Systems, Inc., San Jose, CA (US)

(21) Appl. No.: 12/714,234

(22) Filed: Feb. 26, 2010

(51) Int. Cl. G06F 17/30

(52) U.S. Cl. 707/758; 707/785; 707/E17.005; 707/E17.014; 707/E17.032

(57) ABSTRACT

Briefly, embodiments of a method, apparatus or article for group access control of a distributed system are described.

### BACKGROUND

1. Field

The present disclosure relates generally to distributed processing and, more particularly, to access management for distributed computing environments.

2. Information

In a distributed computing environment, users may interact with one or more applications or processes that may reside on a number of network-interconnected computing platforms, autonomous or otherwise, that may be distributed, for example, throughout one or more geographic areas or regions (e.g., location-wide, state-wide, world-wide, etc.) and may appear to users as a single coherent computing platform or system. Typically, although not necessarily, a distributed system may comprise any number of computing platforms or other like server-based or client-based computing devices (e.g., personal computers, digital assistants, cellular phones, set-top boxes, etc.) that may have sufficient processing or storage capabilities to participate in a distributed system. As such, distributed systems may provide to users enhanced processing power or increased storage capacity (e.g., than individual computing platforms, etc.) to perform tasks or maintain data or information.

Distributed systems may be managed or otherwise supported by one or more geographically dispersed server farms or clusters that may respectively represent one or more data centers to allow for a more fault-tolerant computing environment. For example, a data center may maintain a database (e.g., for a web-based service or platform, etc.) for users to conveniently create, manage, store, or exchange visual or other types of content via an electronic network, an intranet, the Internet, etc. A database may contain user log-ins, authentication credentials, preference settings, etc. and may serve a large number of geographically scattered users that may be logged into multiple web services (e.g., a group of users, etc.). For fault tolerance or performance reasons, for example, a database may be replicated or partitioned over a plurality of points (e.g., computing platforms, servers, etc.) over a network in a given data center or multiple data centers located among various geographic regions. One or more distributed processing techniques may be implemented for replication so as to improve continuity or provide a robust computing environment that may be readily or efficiently accessible by a large number of distributed computing platforms associated with geographically dispersed users or groups of users in a distributed system.

In a distributed computing environment, content accessibility may be administered, for example, by controlling a capability of users or groups of users to read, write, create, delete, execute, maintain, etc. information or content associated with a distributed system. As the size of networks and, therefore, the load of network services increases (e.g., systems become more massively distributed), complexity of distributed processing in general and access control management in particular also may increase. Accordingly, it may be desirable to develop one or more methods, systems, or apparatuses that may implement more efficient processing to support, content distribution or access control capabilities for a distributed system.

### BRIEF DESCRIPTION OF THE DRAWINGS

Non-limiting and non-exhaustive embodiments will be described with reference to the following figures, wherein like reference numerals refer to like parts throughout the various figures unless otherwise specified.

FIG. 1 is a schematic diagram illustrating an implementation of group access control in a distributed system.

FIG. 2 is a flow diagram illustrating an implementation of a process for group access control for in a distributed system.

FIG. 3 is a schematic diagram illustrating an implementation of a computing environment associated with one or more special purpose computing apparatuses.

FIG. 4 is a schematic diagram illustrating an implementation of group access control in a distributed system at a high level.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some examples of methods, apparatuses, or articles of manufacture are disclosed herein that may be used to improve or otherwise administer access control or management for one or more users or groups of users on electronic content or object(s) associated with a distributed computing environment, such as, for example, securable content or objects. As used herein, “electronic content,” “electronic content,” or “object(s)” may be used interchangeably and may refer to one or more signals representing signal information capable of being processed electronically by a special purpose computing apparatus during one or more computing tasks, including being displayed, played to or by a user, or to which access may be controlled or otherwise managed. As a way of illustration, electronic content or object(s) may include visual content, such as, for example, one or more files, folders, images, HyperText Markup Language (HTML) web pages, e-mails, software applications, Extensible Markup Language (XML) documents, video, or other visual information, including text or motion of an interactive user environment that may be represented as one or more icons or fields in a graphical user interface (GUI) of a computing application or platform associated with a user or a group of users. In certain implementations, electronic content may comprise audio content including, for example, web-based audio, MP3 files, Windows Media Audio (WMA) files, or other audio information. In an implementation, for example, a special purpose computing apparatus or platform may include speakers or a microphone. Audio content may be accessed or controlled via an input device or through commands that may be processed using any voice or speech recognition-related technology. As will be described in greater detail below, electronic content may also contain one or more embedded or attached references (e.g., access control lists, property-value arrays, metadata descriptors, etc.) that may include one or more relevant items of information stored in a searchable format that may associate a particular user or a group of users with various access or management rights or permissions corresponding to electronic content or object(s), such as securable content or objects. It should be noted, however, that these are merely illustrative examples relating to electronic content that may be associated with a distributed system, and claimed subject matter is not limited in this regard.

Before describing some examples of methods, apparatuses, or articles of manufacture in greater detail, the sections below first introduce certain aspects of an example operating environment, computing or otherwise, in which group access control may be performed. It should be appreciated, however, that claimed subject matter are not limited to these example implementations. For example, techniques provided herein may be adapted for use in a variety of information processing environments, such as, distributed computing, parallel or sequential computing, database-centric applications, message passing-based communication or processing, etc. In addition, any implementations or configurations described herein as “example” are described for purposes of illustrations.

As previously mentioned, a distributed system may employ a number of network-interconnected computing platforms or servers or may provide enhanced processing or storage capabilities to users or groups of users. Typically, although not necessarily, a distributed system may include one or more server-based special purpose computing platforms or devices (e.g., server devices) that may be communicatively coupled to a network with one or more other special purpose server devices or client-based special purpose computing platforms or devices (e.g., client devices). A “network,” “distributed system,” “client-server system,” “peer-to-peer system,” or the plural form of such terms may be used interchangeably or may refer to a plurality of computing platforms communicatively coupled together via one or more information links or communication devices (e.g., adapters, routers, etc.) that may, for example, share resources, perform tasks, or otherwise communicate through transmission or receipt of information over suitable communication media (e.g., wireless, wired, optical fibers, satellite communications, etc.) according to one or more communication protocols (e.g., HyperText Transfer Protocol (HTTP), File Transfer Protocol (FTP), etc.).

In certain implementations of a distributed computing environment, one or more computing platforms may function as server devices or as client devices (e.g., in a client-server configuration or network), or may function, for example, as peer devices serving at times as both server and client devices (e.g., in a peer-to-peer configuration or network). As a way of illustration, in a client-server network, one or more server devices may operate as a hub to implement one or more processes, serving one or more client devices, including, for example, a desktop computer, a laptop computer, or a PDA. Users working on client devices may be provided advantages such as, for example, improved communications (e.g., bandwidth, etc.) or collaboration among one another, for example.

To illustrate, a computer platform may serve applications or services in response to requests from other computing platforms or devices (e.g., users, etc.) or may function or otherwise be characterized herein as a server device. Services may include, for example, performing specific tasks (e.g., web site hosting or presence, graphics editing or publishing, streaming audio or video content, etc.), assigning or resolving network names or addresses (e.g., e-mail servers, domain name servers, etc.), storing or retrieving information or resources (e.g., distributed database management, etc.), responding to search requests or queries (e.g., search engine services, etc.) or the like. As will be seen, server devices may include, for example, a processing unit that may be operatively coupled to a system memory or like information repository or may host one or more processes or applications to support processing tasks in a distributed computing environment, for example.

In an implementation, one or more computing platforms may communicate with or may solicit or request services or electronic content from server platforms or devices or may be characterized as client computing platforms or devices. A client device, for example, may comprise a special purpose computing apparatus or platform having a memory and a processor capable of executing instructions represented by one or more electrical digital signals. As illustrated in example implementations, users or groups of users may access electronic content or may carry out tasks (e.g., editing, storing, sharing, etc.) on a variety of special purpose client computing platforms or devices in coordination with one or more server computers or devices, such as in a distributed network or system, for example.

Special purpose client devices, which may herein be referred to as client devices, may further include a display and a graphical user interface (GUI) to present, for example, visual content with respect to one or more processing tasks. As used herein, GUI may refer to a program interface that utilizes displayed graphical information to allow a user to access or manage a special purpose computing platform by a pointer or pointing device or other peripheral device or mechanism. A pointer, for example, may refer to a cursor, arrow, or other symbol that may appear on a display or may be moved or controlled with a pointing device to select or populate fields or input commands via a GUI of a special purpose computing platform. A pointing device may refer to any device used to control a cursor or arrow to select objects or input commands via a GUI of a special purpose computing platform. Pointing devices may include, for example, a mouse, a trackball, a track pad, a track stick, a keyboard, a stylus, a digitizing tablet, or similar types of devices. Herein, terms such as “click” or “clicking” may refer to a selection process made by any pointing device, such as a mouse, for example, but use of such terms is not intended to be so limited. For example, a selection process may be made via a touch screen. For example, “clicking” may be replaced by “touching.” However, these are merely examples of methods of selecting objects or inputting information and claimed subject matter is not limited in scope in these respects.

It should be appreciated that there may be no single type of special purpose client device with which a user or a group of users may choose to access or manage electronic content associated with a distributed system. Users may work with various types of special purpose devices that may have a variety of resident or add-on applications, including a thin client computing device (e.g., network appliance), a desktop computing device, a mobile phone, or a personal digital assistant (PDA), just to name a few examples. In an implementation, a client device may include a network browser or similar-type application that may enable a client device to access or display electronic content located on one or more server devices associated with a distributed network or system, such as, for example, a local area network (LAN), a wide area network (WAN), the World Wide Web, the Internet, or the like.

In an example implementation, one or more server devices may provide a host environment that may comprise a special purpose multimedia computing platform which may include one or more host applications, such as, for example, Adobe Photoshop® Elements® graphics editing program, available from Adobe Systems Incorporated of San Jose, Calif., and at www.photoshop.com, which may provide a dynamic virtualized platform for users or groups of users to conveniently create, access, edit, store, or share or publish electronic content or objects (e.g., pictures, files, folders, etc.) over a public electronic network, such as the Internet. As the terms used herein, “share” or “publish” may refer to saving or otherwise uploading electronic content or associated information to one or more server devices on a distributed network, where content or associated information may be accessible to one or more users or a group of users.

An application programming interface (API) provided by a special purpose host or server computer may be used to support a GUI on one or more client devices such that relatively seamless integration may be possible between one or more varying client-based resident programs (e.g., on client devices) for sharing or organizing electronic content. In this example, browser-deployed applications may facilitate user interaction with electronic content relatively independent of hardware or software capabilities that may be available on client devices (e.g., as a service), or electronic content may be stored on one or more server devices after being created. Thus, a relatively small software load may be advantageously experienced by a thin client device, such as a PDA, for example, while one or more network-interconnected server devices may carry a fuller load of multiple applications, services, or stored information. Accordingly, an implementation may provide users with an efficient, convenient, or easy-to-use visual experience for creating or sharing electronic content or may improve communication or collaboration among multiple users or groups of users.

Optionally or alternatively, electronic content may be accessed or downloaded from a host or server device (e.g., under a license, etc.) or stored locally on a client device for further editing, sharing, etc. (e.g., in a peer-to-peer configuration). Of course, various implementations of host environments or associated applications are possible, and it is not intended to limit claimed subject matter to a particular implementation.

As geographic barriers to personal travel or information technology decrease, there may be an increasing utilization of browser-deployed applications or server-based user information from geographically dispersed areas of the globe, for example. As previously mentioned, to improve bandwidth (e.g., for access to information from multiple users throughout a distributed system) or reduce disc resource consumption, one or more applications, files, folders, etc., or digital electrical signals representing electronic content may be replicated or stored, partially or substantially, on any portion or point in a distributed system or network. For example, to serve geographically scattered users, a distributed system may include one or more server clusters or data centers placed throughout various geographic areas or regions. Typically, although not necessarily, a data center may assign individual user accounts to various users or may provide to users a storage space where electronic content may be maintained or accessed by one or more users or groups of users.

Under some circumstances, a data center in a geographically distributed system may be requested to serve a multitude of user requests (e.g., user authentications, access requests, permission renewals or updates, etc.) substantially simultaneously from virtually any part of the globe with low latency. To efficiently serve requests or to maintain consistency or redundancy of electronic content throughout a distributed system, multiple replica copies of content may be placed in various data centers or server devices, for example, within one or more geographic regions or around the world, as previously mentioned. In an implementation, a management or directory service, which may comprise a special purpose computing apparatus executing software that performs one or more management or directory service processes utilizing suitable application protocols (e.g., Lightweight Directory Access Protocol or LDAP, etc.) may be used to synchronize or modify electronic content across various points in a distributed system. A user, for example, may access a replica copy of electronic content located at a data center that may be quickly accessible by that user.

Maintaining replica copies of electronic content at multiple data centers or server devices, however, may not be efficient and, in some cases, may be relatively expensive due to constraints on network bandwidth, storage space, or aggregate costs of replicating, distributing, or maintaining replica copies of electronic content at a variety of data centers or server devices. Adaptive placement of copies (e.g., access requests associated with a given data center) may also be undesirable due at least in part to costs or overhead associated with coordination across individual data centers, as well as consumption of valuable memory space (e.g., for access count statistics, etc.), which may normally be used for caching electronic content on server devices.

In addition, achieving a placement of replica copies of electronic content within a distributed system may involve a single content management server device (e.g., central or master directory server, etc.) at a given data center initially collecting or authenticating, and then distributing or updating (e.g., via LDAP, etc.), user accounts information or electronic content on its constituent devices across a distributed network. A procedure for authenticating or delivering electronic content from a localized central starting point may negatively impact latency in responses from a given data center (e.g., create an informational bottleneck) or make a distributed system more prone to failure due to decreased redundancy (e.g., via a single point of failure at a master directory server), for example.

As illustrated in the example implementations, access control or authentication procedures or processes for users or groups of users may be improved or streamlined by utilizing searchable information that may be embedded or attached to one or more objects or user accounts on a distributed computing network, such as, for example, a massively distributed system. As will be seen, searchable information may be in the form of access control lists (ACLs) that may be distributed across a network (e.g., with corresponding objects), which may increase a throughput of a distributed system (e.g. by reducing informational bottlenecks) or may help to maintain redundancy for recoverability (e.g., reduce risks associated with a single point of failure). Searchable information may also be in the form of group membership lists that may be stored in user accounts or may be queried to determine whether a user belongs to a particular group. For example, users' group membership lists or ACLs associated with objects may be intersected or access rights or permissions for users may be determined based, at least in part, on an intersection process, as will be described in greater detail below. An intersection process, for example, may reduce authentication or permission-related lag times that may exist in a distributed processing environment involving multiple users.

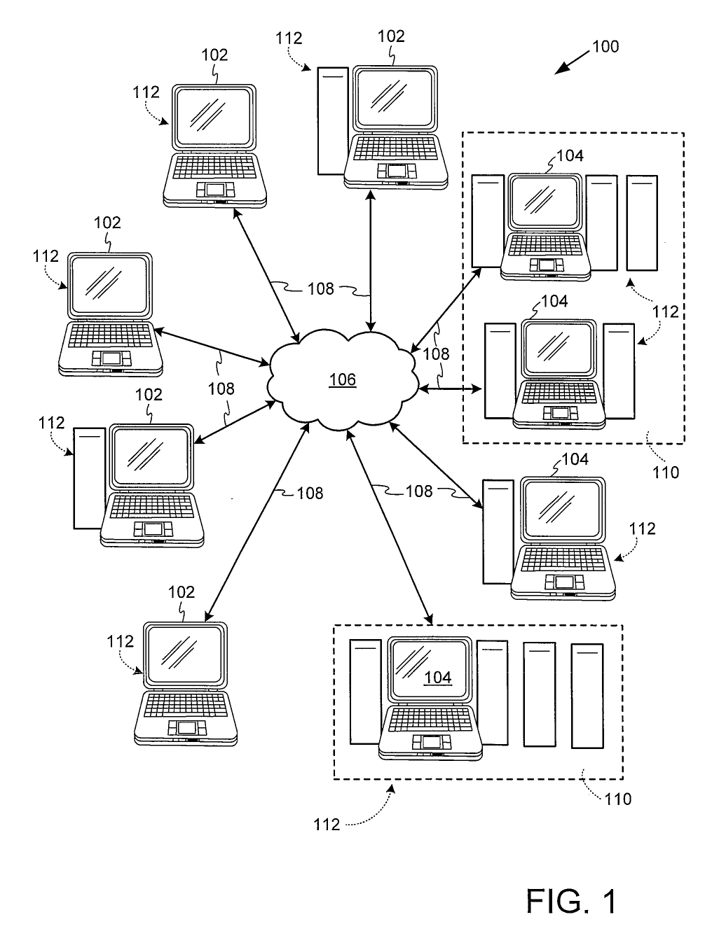

With this in mind, attention is drawn to FIG. 1, which is a schematic diagram illustrating an example system 100 that may be operatively capable of performing group access control in a distributed computing environment. As described herein with reference to particular example implementations, system 100 may be operatively capable using one or more special purpose computing apparatuses, information communication devices, information storage devices, computer-readable media, applications or instructions, various electrical or electronic circuitry or components, input data signals, etc. Example system 100 may be implemented in the context of one or more communication networks, such as, for example, public networks (e.g., the Internet, the World Wide Web), private networks (e.g., intranets), local area networks (LAN), wide area networks (WAN), virtual private networks (VPN), wireless networks, or the like.

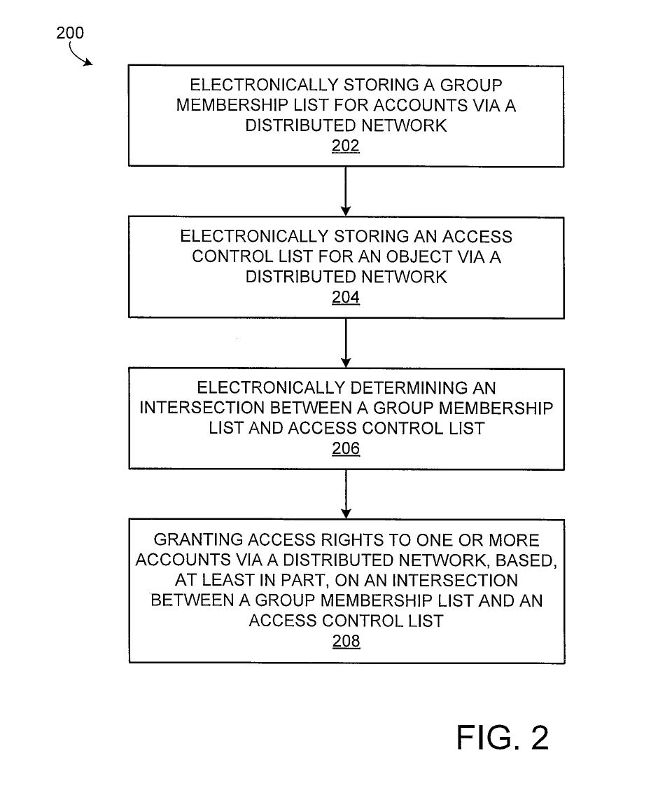

As illustrated in the present example, system 100 may include a number of computing platforms or devices, such as, for example one or more client computing platforms or devices 102 or one or more server computing platforms or devices 104, which may be operatively coupled by use of a communications network 106. Even though only a certain number of client devices 102 or server devices 104 are illustrated in FIG. 1, any number of server or client devices may be operatively coupled via communications network 106 to facilitate one or more processes associated with system 100. It should also be noted that even though system 100 is illustrated in a client-server architecture or configuration, all or any computing devices 102 and 104 may function as both server and client devices, for example, in a peer-to-peer network architecture or configuration of system 100 to provide or otherwise support one or more processes associated with group access control. An example implementation of a process employing group access control will be described in greater detail below with reference to FIG. 2.

As previously mentioned, respective client or server devices 102 and 104 may include one or more communication adapters, modems, network interface cards or other like components that may facilitate transmission or receiption of information from communications network 106 via one or more communication channels or links 108 according to one or more communication protocols (e.g., HTTP, FTP, etc.). Server or client devices may include one or more processing units, input/output devices, such as, for example, a display, a keyboard, a mouse, a GUI, or one or more types of memory (e.g., random access memory, read only memory, flash memory, etc.).

Client devices 102 may comprise, for example, any kind of computing device, mobile device communicating or otherwise having access to the Internet over a communications network 106 (e.g., desktop computers, laptop computers, notepads, personal digital assistants, cellular phones, etc.). Client devices 102 may include a browser or a user interface that may initiate transmission of one or more electrical digital signals representing a service request, for example. A browser may facilitate an access to system 100 or viewing of electronic content over the Internet (e.g., via HTTP, etc.), for example, or electronic content specifically formatted for mobile communication devices (e.g., via WML, XHTML Mobile Profile, WAP 2.0, C-HTML, etc.). User interface of client devices 102 may comprise any appropriate input approach (e.g., keyboard, mouse, touch screen, digitizing tablet, etc.) or output approach (e.g., display, speakers, etc.) suitable for a user interaction with client devices 102, as mentioned above.

In a configuration, one or more server devices 104, for example, may perform one or more services or tasks, such as, for example, hosting one or more applications (e.g., Adobe Photoshop® Elements® graphics editing program, etc.), web site publishing or sharing (e.g., at www.photoshop.com, etc.), audio or video content streaming, etc., or may be able to implement or otherwise support group access control for a system that may have no dedicated or centralized user database. Server devices 104 may maintain one or more information repositories or databases that may store one or more electrical digital signals representative of host applications, user log-ins, authentication credentials, preference settings, etc. Optionally or alternatively, server devices 104 may maintain replica copies of electronic content to provide, for example, decreased latency access for user requests or to maintain consistency or scalability of system 100, as previously mentioned.

In an implementation, server devices 104 may be clustered or otherwise organized into one or more data centers, as indicated generally in dashed lines at 110, though claimed subject matter is not so limited. In an implementation, data centers may utilize one or more management or directory services, for example, to oversee or manage electronic content, or to synchronize or modify electronic content across various portions or points in system 100, as previously mentioned. In addition, although not shown, it should be noted that one or more load balancing techniques or processes may be implemented, for example, to distribute a workload, balance utilization of a bandwidth or throughput associated with system 100 (e.g., utilizing application layer proxies, etc.). Optionally or alternatively, one or more application delivery features or processes may be utilized, for example, to aid in a deployment or delivery of applications.

As previously mentioned, optionally or alternatively, computing devices 102 or 104 may function, for example, as peer devices or may engage in peer-to-peer communications that may be supported by or otherwise associated with example system 100. In this particular example, devices 102 or 104 may perform similar actions or functions as in a client-server architecture or configuration, such as, for example, provide, host, or share one or more applications or programs; evaluate nodes available for communication or latency time associated with nodes; store, replicate, partition, or assemble one or more objects; store in or associate electronic content with corresponding ACLs or group membership lists; administer access control to electronic content by intersecting users' group membership lists or ACLs associated with content or the like.

As just one example among many possible, computing device 102 may attempt to establish or join a peer-to-peer network with one or more other computing devices of system 100. One or more processor(s) associated with computing device 102 may execute one or more instructions that may allow computing device 102 to establish or join a peer-to-peer network that may mirror, for example, an architectural footprint or a topology of distributed system 100. In an implementation, computing device 102 may function and, thus, may be characterized as a peer node or device, as indicated by dashed arrow 112. As used in the context, a peer device may refer to one or more processes hosted on a special purpose computing apparatus or platform, which may perform functions similar to a server device at times, while also performing functions similar to a client device at times. Likewise, other devices 102 or 104 may function or may be characterized as peer nodes or devices 112. Accordingly, peer nodes or devices 112 may communicate with one another to share resources, electronic content, or otherwise facilitate one or more processes associated with distributed system 100. Of course, it should be noted that these are merely illustrative examples relating to example system 100 employing a peer-to-peer network architecture or configuration and that claimed subject matter is not limited in this regard.

FIG. 2 is a flow diagram illustrating an example process 200 for performing group access control for a distributed system. Example process 200 may begin with a user at a computing platform or device accessing a service of interest, such as, for example, a browser-deployed Adobe Systems' Photoshop® Elements® graphics editing application, via the Internet or other communications network or creating a log-in or user account. For example, a user's computing device may transmit or a server computing platform or device (e.g., associated with that service) may receive one or more electrical digital signals representative of a user's profile or authentication information (e.g., user name or ID, password, privacy or communication preferences, address or billing information, etc.). After information is received, a system may assign, for example, individual user accounts to one or more users, although claimed subject matter is not limited in this respect. In an implementation, a server device may communicate a conditional acknowledgment or other information to a user's computing device to complete an account set-up or to reconfirm authentication information (e.g., e-mail verification information, temporary password, subscription or enrollment fee confirmation, etc.), or a user may provide an acknowledgment response. Creation of network accounts is a known administrative task and need not be described here in greater detail.

Any profile information or preferences indicated by a user may be stored, for example, as one or more electrical digital signals in a database record associated with that user's name or account on a distributed network. User account information may be stored, for example, in a data center that is accessible to that user (e.g., geographically, communicatively, etc.). Optionally or alternatively, one or more replica copies of information may be transmitted for subsequent storage to various points (e.g., data centers, server devices, etc.) across a network for consistency, redundancy, etc., as previously mentioned. It should be appreciated that user account information may be placed strategically or its allocation may be changed easily on a global basis or on a local or regional basis. In an implementation, a special purpose client device utilizing a browser may communicate with one or more peer devices, for example, to download software to a client device (e.g., in a peer-to-peer configuration) so as to create or establish a local user profile or account to share or collaborate on electronic content via a client or peer device relatively independent of specific browser-deployed network services or applications.

In an implementation, a user, such as an owner of electronic content, may invite one or more other users to read or view (e.g., access, share, etc.) or write or collaborate (e.g., edit, copy, upload, print, create directory, etc.) on electronic content created by such user or may join other users in viewing or collaborating on their electronic content. A user may create or join an entity that may be referred to herein as a “group” comprising of multiple users or user accounts or may define or assign a set of access rights or permissions (e.g., on that user's electronic content) to such users by listing them as members of a particular group. This may reduce lag times that may exist in an authentication or access control process involving multiple users by reducing desirability of separate ACLs or separate entries to ACLs for new users or user accounts. For example, a system may look up a name of a group on a group membership list to which a particular user belongs or a member of to grant access rights to such a user based, at least in part, on permitted actions allowed for such a group in a corresponding ACL, as will be described below.

At operation 202, one or more group membership lists may be embedded or attached (e.g., as tags, etc.) to or may be stored, for example, as one or more electrical digital signals in a database record associated with one or more corresponding user accounts on a distributed network. As indicated above, a user may log-in onto a user account on a service network or otherwise establish a session utilizing one or more suitable communication protocols (e.g., HTTP, FTP, TCP, etc.) to begin participation in process 200. As the term used herein, a “session” may refer to a communications period during which one or more processes associated with computing platforms or devices may communicate over a network to perform one or more tasks, operations, or functions. For example, a session may be established between a client device and a server device at or via a log-in service session during which a group membership list may be queried or otherwise accessed, as will be particularly described with reference to operation 208. Under some circumstances, a session may be established between computing devices as peers (e.g., in a peer-to-peer configuration), as previously mentioned. One or more group membership lists may be embedded or attached, for example, to a user profile or account associated with a peer node or device. Accordingly, a group membership list may be stored locally on a peer device as one or more electrical digital signals that may be queried or otherwise accessed at any time during a peer-to-peer session (e.g., at load time, log-in, viewing, editing, etc.).

Although claimed subject matter is not limited in scope in this respect, one or more group membership lists may be stored in the form of one or more binary tree storage arrangements. As used in the context, a “binary tree” may refer to an ordered collection of signal values that may be organized as one or more roots having at most two child nodes that may branch off from a root at various levels of the collection, wherein the signal value at a root is more than the signal values stored in the left child nodes and less than the signals values stored in the right child nodes. A binary tree arrangement, for example, may provide a quick or efficient search or look up mechanism that may reduce time associated with a search with respect to one or more signal values. For example, signal values may represent names of groups associated with a particular user account stored in a lexicographically sorted order (e.g., B is greater than A, C is greater than B, etc.), though claimed subject matter is not so limited.

At operation 204, a process may execute instructions on a special purpose computing apparatus to store one or more electrical digital signals representative of an access control list, for example, as embedded or otherwise attached information (e.g., metadata, payload, etc.) within electronic content or an object on a distributed network.

Information may include, for example, the date an object was created or modified, the owner of an object, size or type of an object, etc. As the term used herein, an “access control list” or ACL may refer to one or more data structures (e.g., lists, tables, etc.) that may define or otherwise specify one or more access rights or permitted actions that one or more users or groups of users may perform on one or more objects. Examples of permitted actions may include permissions to read, write, create directory, delete, execute, or the like.

In an implementation, information embedded or attached to an object may include entries or fields, for example that may be defined as “acl_read” and “acl_write.” As a way of illustration, the field “acl_read” may comprise, for example, an ACL of users and groups of users that may have permissions to read an object, and “acl_write” may comprise an ACL of users and groups of users that may have permissions to write or delete an object. Similarly to group membership lists of the above examples, one or more ACLs may be stored in the form of one or more binary tree storage arrangements having signal values representative of names of users and groups associated with that user, and lists may be lexicographically sorted. Of course, claimed subject matter is not limited in scope to employing these particular arrangements or to the approach employed by these particular arrangements. Rather this is merely provided as one example of an implementation including described capability; however, many other approaches to providing this capability may be available and claimed subject matter is not limited in scope to any particular approach.

An example process may proceed at operation 206, where an intersection between one or more group membership lists and one or more ACLs may be determined. In an implementation, determining an intersection may associate one or more electrical digital signals representative of a group membership list with signals representative of an ACL, such that authorized access rights may be invoked. For example, a user that accepted an invitation to read or write to one or more objects (e.g., non-owner), as mentioned above, may initially request or otherwise try to gain access to an object. After an attempt to retrieve an object is made, an ACL associated with that object may be queried to determine if that particular (e.g., requesting) user has access rights that may authorize requested actions. A determination may be made, for example, by searching for matches to a requesting user's name in a sorted list of ACL's entries (e.g., “acl_read” and “acl_write”) associated with a requested object. In an implementation, a binary search may be performed on ACLs. A search may be performed, for example, using various techniques or processes and need not be described here in detail. As a way of illustration, a dichotomic, divide and conquer, etc. search process may be used among a plurality of binary search approaches to find a target value in a sorted list. These or other like processes or procedures may be implemented, in whole or in part, to provide or otherwise support search or look up of users or groups at operation 206.

If a match to a requesting user's name is found in an ACL, then further search may be omitted and a user may be granted access in accordance with an ACL's user name entries. If no ACL is found for that particular user, however, a query may be made against that user's group membership. For example, one or more electrical digital signals representative of ACL's group membership entries associated with a requested object may be transmitted over a network to one or more server devices with a database record associated with a requesting user account. Likewise, a binary search on a user's membership may be performed. If any group entry is matched with a group to which a requesting user belongs (e.g., group membership lists are intersected), access rights to a user may be granted, for example, at operation 208.

Optionally or alternatively, user participation in process 200 may occur off-line, for example, wherein a network server device (e.g., in a client-server configuration) or a peer device (e.g., in a peer-to-peer configuration) may transmit an e-mail or other electronic communication that may include electronic content or associated information (e.g., group membership lists, etc.) to one or more users. Respective one or more group membership lists may be intersected, for example, in a peer node or device, for example, at any time during a peer-to-peer session (e.g., at load time, log-in, viewing, editing, etc.). It should be noted that electronic content or associated information may be encrypted for security reasons. Encryption may be applied to all or part of electronic content or associated information.

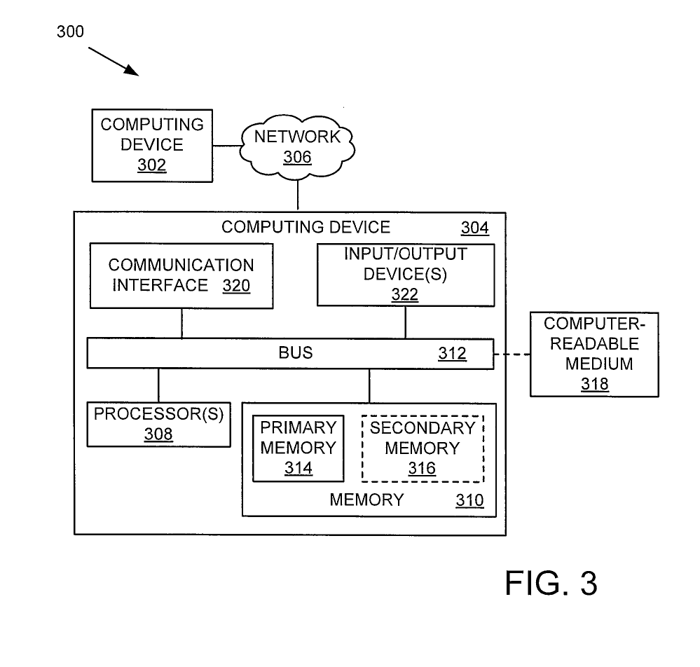

FIG. 3 is a schematic diagram illustrating an example computing environment 300 that may include one or more devices that may be configurable to partially or substantially implement a process for performing group access control for a distributed system. Computing environment system 300 may include, for example, a first device 302 and a second device 304, which may be operatively coupled together via a distributed network 306. Although not shown, optionally or alternatively, there may be additional like devices operatively coupled to network 306

In an embodiment, first device 302 and second device 304 may be representative of any electronic device, appliance, or machine that may have capability to exchange information over network 306. For example, first device 302 and second device 304 may include: one or more computing devices or platforms, such as, e.g., a desktop computer, a laptop computer, a workstation, a server device, data storage units, or the like.

Distributed network 306 may represent one or more communication links, processes, or resources having capability to support exchange or communication of information between first device 302 and second device 304. By way of example but not limitation, network 306 may include wireless or wired communication links, telephone or telecommunications systems, data buses or channels, optical fibers, terrestrial or satellite resources, local area networks, wide area networks, intranets, the Internet, routers or switches, or the like.

It should be appreciated that all or part of various devices or networks shown in computing environment system 300, or processes or methods as described herein, may be implemented using or otherwise include hardware, firmware, or any combination thereof along with software.

Thus, by way of example but not limitation, second device 304 may include at least one processing unit 308 that may be operatively coupled to a memory 310 through a bus 312. Processing unit 308 may represent one or more circuits to perform at least a portion of one or more information computing procedures or processes. As a way of illustration, processing unit 308 may include one or more processors, controllers, microprocessors, microcontrollers, application specific integrated circuits, digital signal processors, programmable logic devices, field programmable gate arrays, or the like.

Memory 310 may represent any data storage mechanism. For example, memory 310 may include a primary memory 314 and a secondary memory 316. Primary memory 314 may include, for example, a random access memory, read only memory, etc. While illustrated in this example as being separate from processing unit 308, it should be appreciated that all or part of primary memory 314 may be provided within or otherwise co-located/coupled with processing unit 308.

Secondary memory 316 may include, for example, the same or similar type of memory as primary memory or one or more data storage devices or systems, such as, for example, a disk drive, an optical disc drive, a tape drive, a solid state memory drive, etc. In certain implementations, secondary memory 316 may be operatively receptive of, or otherwise have capability to be coupled to, a computer-readable medium 318. Computer-readable medium 318 may include, for example, any medium that can store or provide access to information, code or instructions for one or more devices in system 300.

Second device 304 may include, for example, a communication adapter or interface 320 that may provide for or otherwise support communicative coupling of second device 304 to a distributed network 306. By way of example but not limitation, communication adapter or interface 320 may include a network interface adapter or card, a modem, a router, a switch, a transceiver, or the like.

Second device 304 may include, for example, an input/output device 322. Input/output device 322 may represent one or more devices or features that may be able to accept or otherwise input human or machine instructions, or one or more devices or features that may be able to deliver or otherwise output human or machine instructions. By way of example but not limitation, input/output device 322 may include a display, speaker, keyboard, mouse, trackball, touch screen, data port, or the like.

Thus, as illustrated in various example implementations or techniques presented herein, in accordance with certain aspects, a method may be provided for use as part of a special purpose computing device or other like machine that accesses digital signals from memory or processes digital signals to establish transformed digital signals which may be stored in memory as part of one or more data files or a database specifying or otherwise associated with an index.

According to an implementation, one or more portions of an apparatus, such as second device 304, for example, may store one or more binary digital electronic signals representative of information expressed as a particular state of a device, for example, second device 304. For example, an electrical binary digital signal representative of information may be “stored” in a portion of memory 310 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, for example, memory device 310, to a different state or thing.

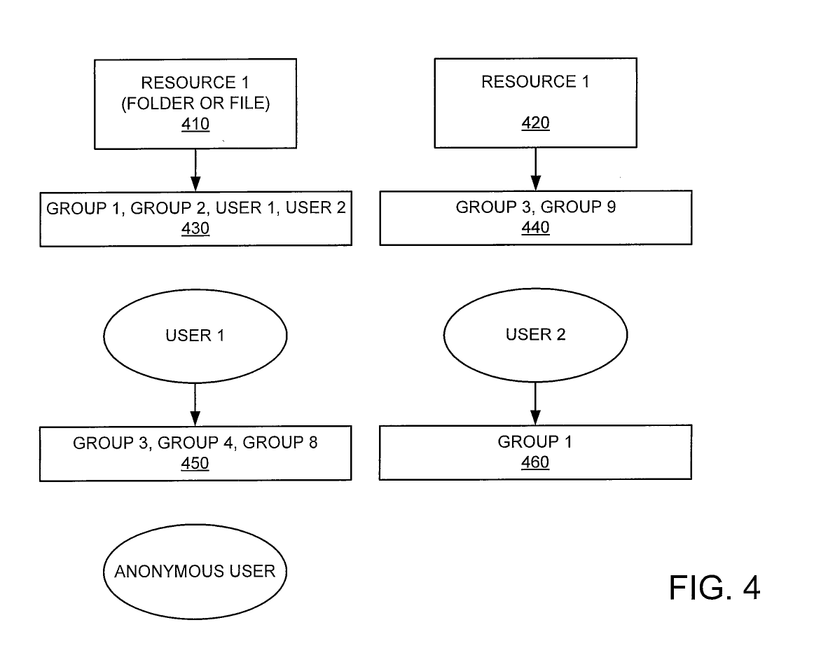

FIG. 4 is a schematic diagram illustrating an implementation of group access control in a distributed system at a high level. For example, resources 410 and 420 are associated with various groups or users, such as 430 and 440 respectively. Likewise, users 1 and 2 are associated with particular groups, such as 450 and 460 respectively.

While certain example techniques have been described and shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

1. A method, comprising:
electronically storing a group membership list for one or more accounts;
electronically storing a plurality of objects at different locations in a distributed computing system;
electronically storing a separate access control list for each of the plurality of objects, wherein searchable data defining each respective access control list for each respective object is embedded in or attached to the respective object, such that each respective access control list is located with its respective object at the different locations in the distributed computing system; and
electronically determining an intersection between said group membership list and the respective access control list for one of the plurality of objects to be accessed.

2. The method of claim 1, wherein said electronically storing a group membership list for one or more accounts comprises electronically storing a group membership list for one or more accounts on a distributed network; and
said electronically storing an access control list for an object comprises electronically storing an access control list for an object on a distributed network.

3. The method of claim 2, wherein said object comprises a securable object.

4. The method of claim 3, and further comprising: granting access rights to said one or more of said accounts on said distributed network based, at least in part, on the determined intersection between said group membership list and said access control list.

5. The method of claim 4, wherein said granting access rights with respect to said securable object comprises at least one of the following: granting permission to open said securable object; granting permission to read said securable object; granting permission to write to said securable object; granting permission to delete said securable object; granting permission to make a directory of said securable object; or any combination thereof

6. The method of claim 3, wherein said access control list for said securable object is stored within said securable object.

7. The method of claim 3, wherein said electronically determining an intersection comprises matching at least one of the following: a user name of said one or more accounts in said group membership list with a user name in said access control list.

8. The method of claim 7, wherein a user name of said one or more accounts comprises one or more group accounts on said distributed network.

9. The method of claim 3, wherein said group membership list and said access control list are stored as binary tree storage arrangements.

10. The method of claim 9, wherein said lists are stored as one or more lexicographically sorted lists.

11. The method of claim 9, wherein said electronically determining an intersection between said group membership list and said access control list includes performing a binary search of said binary tree storage arrangements.

12. The method of claim 3, wherein said securable object comprises at least one of the following: a file; or a folder.

13. An article, comprising:
a non-transitory computer-readable storage medium having instructions stored thereon executable by a special purpose computing platform to:
electronically store a group membership list for accounts;
electronically store a plurality of objects at different locations in a distributed computing system;
electronically store a separate access control list for each of the plurality of objects, wherein searchable data defining each respective access control list for each respective object is embedded in or attached to the respective object such that each respective access control list is located with its respective object at the different locations in the distributed computing system; and
electronically determine an intersection between said group membership list and the respective access control list for one of the plurality of objects to be accessed.

14. The article of claim 13, wherein said instructions are further executable by a special purpose computing platform to:
electronically store a group membership list for accounts on a distributed network; and
electronically store an access control list for an object on a distributed network.

15. The article of claim 14, wherein said instructions are further executable by a special purpose computing platform to: electronically store an access control list for a securable object.

16. The article of claim 15, wherein said instructions are further executable by a special purpose computing platform to: grant access rights to said one or more of said accounts on said distributed network based, at least in part, on a determined intersection between said group membership list and said access control list.

17. The article of claim 15, wherein said instructions are further executable by a special purpose computing platform to: store said access control list for said securable object within said securable object.

18. The article of claim 15, wherein said instructions are further executable by a special purpose computing platform to determine an intersection through matching at least one of the following: a user name of said one or more accounts in said group membership list; or a user name in said access control list.

19. The article of claim 18, wherein said instructions are further executable by a special purpose computing platform so that a user name of said one or more accounts comprises one or more group accounts on said distributed network.

20. An apparatus, comprising:
a special purpose computing platform having capability to:
electronically store a group membership list for accounts;
electronically store a plurality of objects at different locations in a distributed computing system;
electronically store a separate access control list for each of the plurality of objects, wherein searchable data defining each respective access control list for each respective object is embedded in or attached to the respective object such that each respective access control list is located with its respective object at the different locations in the distributed computing system; and
electronically determine an intersection between said group membership list and the respective access control list for one of the plurality of objects to be accessed.

21. The apparatus of claim 21, wherein said special purpose computing platform further having capability to:
electronically store a group membership list for accounts on a distributed network; and
electronically store an access control list for an object on a distributed network.

22. The apparatus of claim 21, wherein said special purpose computing platform further having capability to electronically store an access control list for a securable object.

23. The apparatus of claim 22, wherein said special purpose computing platform further having capability to grant access rights to said one or more of said accounts on said distributed network based, at least in part, on a determined intersection between said group membership list and said access control list.

24. The apparatus of claim 22, wherein said securable object comprises at least one of the following: a file; or a folder.
